(19) United States
(12) Patent Application Publication
(10) Pub. No.: US 2008/0121349 A1
(43) Pub. Date: May 29, 2008

(54) Retractable panel

(76) Inventor: Jose G. De La Cruz, Prospect Park, NJ (US)

Correspondence Address: LITMAN LAW OFFICES, LTD., P.O. BOX 15035, CRYSTAL CITY STATION, ARLINGTON, VA, 22215, US

(21) Appl. No.: 11/523,623

(22) Filed: Sep. 20, 2006

(51) Int. Cl. E06B 9/00

(52) U.S. Cl. 160/23.1

(57) ABSTRACT

The retractable panel is a length of flexible sheet material rolled onto a roller, with the roller driven by at least one spirator retractor. A spirator may be installed at each end of the roller, in the case of larger, longer, and/or heavier panels. Two such assemblies may be installed in a single housing, in mirror image to one another to operate in opposite directions from a single central location. Decorative and/or other illumination may be included on the roller housing, and the extension of the panels may be motor driven. The lighting and/or motor operation may be directly or remotely controlled. The retractable panel may be adapted to a number of different uses and environments, e.g., as retractable protective wall pads for installation in elevators or other close confines, as vehicle covers, as permanently installed or portable advertising or informational banners, etc.

### BACKGROUND OF THE INVENTION

1. Field of the Invention

The present invention relates generally to flexible sheets, panels, and the like, and particularly to a retractable panel extending from rollers and being selectively extendible and retractable thereon.

2. Description of the Related Art

The general concept of the placement and storage of thin, flexible sheets of material on rollers for deployment and retraction is known in such environments as roller shades for windows and the like, where relatively lightweight material is used for the panel. Such roller shades do not require particularly strong retraction springs or mechanisms, such devices generally using a relatively thin helically coiled wire spring disposed concentrically within the interior of the roller.

However, the use of rollers and retraction springs for larger and heavier sheets of material has generally been limited due to the lack of suitable springs and the difficulty in housing the bulk of the required larger spring with the roller of the assembly while still providing a relatively small diameter core. While larger and heavier springs are known that are adaptable for use in retracting relatively large and heavy sheets of material, such heavy-duty springs have generally not been adapted for such use.

One field in which relatively large and heavy coiled springs are used is the elevator industry, where spirators are generally used in the door operating system. “Spirator” is a generic term for a device comprising an elongate, flat sheet of spring steel coiled in a spiral within a housing. The inner end of the spring is anchored to a fixed central post, which extends from the hub of the device to serve as the anchor for the sprirator. The outer end of the coiled spring has a cable extending therefrom, with the spring urging the cable to retract and wind onto the rotating spirator reel. Spirators are manufactured and supplied by several different companies, e.g., the Westinghouse Corporation of the U.S., the Hee Corporation of South Korea, etc.

However, while numerous devices including rolled, retractable sheets of flexible material have been developed in the past, spirators have never been used in a roller retraction mechanism for a flexible rolled sheet or panel, to the knowledge of the present inventor. An exemplary conventional retractable roller mechanism is shown in Japanese Patent No. 1-101,224, published on Apr. 19, 1989. This device comprises (according to the drawings and English abstract) a vehicle cover comprising two rolled tarps or the like, which extend from a single central housing secured to the top of the vehicle. The retraction springs appear to be helically coiled springs that are concentrically disposed within the roller core.

None of the above inventions and patents, taken either singly or in combination, is seen to describe the instant invention as claimed. Thus, a retractable panel solving the aforementioned problems is desired.

### SUMMARY OF THE INVENTION

The retractable panel is made from a flexible sheet material, which is rolled upon an elongate central roller, similar to a roller shade for a window. However, the retractable panel is formed of a larger sheet of heavier material, and requires a retraction spring having considerably more torque than a conventional roller shade. A helically coiled wire spring of sufficient strength would not conveniently fit within the core of a relatively small diameter tubular core for the rolled sheet or panel.

Accordingly, the retractable panel makes use of a spirator having a spirally coiled flat spring steel spring that urges the roller and flexible panel thereon to a retracted configuration. Two such rollers and spirator assemblies may be installed in a central housing that extend and retract independently and oppositely to one another. A single spirator may be used at one end of the roller to drive each roller in many such devices, depending upon the size of the spirator used, the length and weight of the sheet material of which the panel is formed, etc. This has the advantage of allowing each roller and spirator assembly to be constructed identically, with only the mounting points being interchanged between the two rollers to allow the two rollers to extend and retract oppositely to one another.

In some larger installations, it may be necessary to use two spirators on each roller, where longer lengths of heavier material are used. The use of spirators as the retraction devices for rolled sheets of material may be extended to a number of different uses and environments, e.g., as retractable furniture pads and the like in elevators and similar close confines; as vehicle covers, either using a single or dual roller installation; as an advertising or informational banner, either in a permanent or portable installation; etc. Various forms of illumination and/or decorative lighting may be included, and/or the roller extension may be motorized, if desired. The lighting and/or motor operation may be directly controlled or remotely controlled.

These and other features of the present invention will become readily apparent upon further review of the following specification and drawings.

### BRIEF DESCRIPTION OF THE DRAWINGS

FIG. 1 is an environmental, perspective view of a first embodiment of a retractable panel according to the present invention, showing its operation and use as a protective pad.

FIG. 2 is an environmental perspective view of a second embodiment of a retractable panel of the present invention, showing its operation and use as a vehicle cover.

FIG. 3 is an environmental perspective view of a third embodiment of a retractable panel of the present invention, showing its installation and operation as a load cover for a trash truck or the like.

FIG. 4 is an environmental perspective view of a fourth embodiment of a retractable panel of the present invention, showing its operation and use as an advertising banner.

FIG. 5 is an exploded perspective view of a housing containing two retractable panels according to the present invention and their retraction reels, showing their interrelationship.

FIG. 6 is an exploded perspective view of a single retractable panel assembly according to the present invention having two opposed retraction reels.

FIG. 7 is a schematic view of a retractable panel and reel assembly of the present invention, including lighting and motor drive systems therefor.

Similar reference characters denote corresponding features consistently throughout the attached drawings.

### DETAILED DESCRIPTION OF THE PREFERRED EMBODIMENTS

The present invention comprises various embodiments of a retractable panel formed of a flexible sheet of material (plastic, fabric, etc.) having one end attached to a roller for retractably rolling the panel sheet onto the roller for storage. The device may be in the form of one or more retractable protective pads or wall coverings, a vehicle or vehicle load cover, an informative sign or display, etc., and may incorporate more than one roller and retraction mechanism, depending upon the area to be covered and the weight of the retractable panel or sheet. All embodiments utilize one or more spirator retractors, and may include display, emergency, and/or other lighting means, as desired.

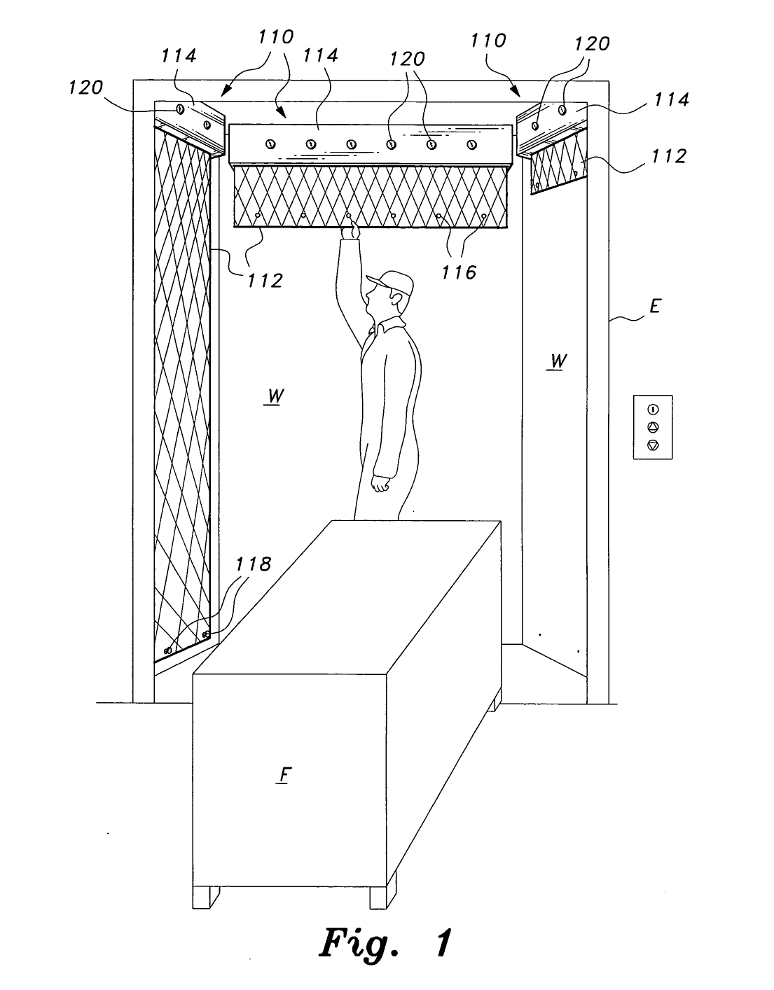

FIG. 1 illustrates a first embodiment of the present invention comprising a retractable protective cover unit 110 for a wall or similar surface, e.g., the interior walls W of an elevator E. The protective cover unit 110 may be provided as a single unit, but preferably a sufficient quantity of the devices 110 are installed to substantially protect all surfaces that may be subject to damage. Separate freight elevators are often not provided in many buildings, with the movement of furniture F (e.g., large, heavy desks, laundry appliances, etc.) being accomplished by means of the passenger elevator(s) E in the building. Conventionally, separate protective pads (if available) are retrieved from a storage location and placed over the walls of the elevator.

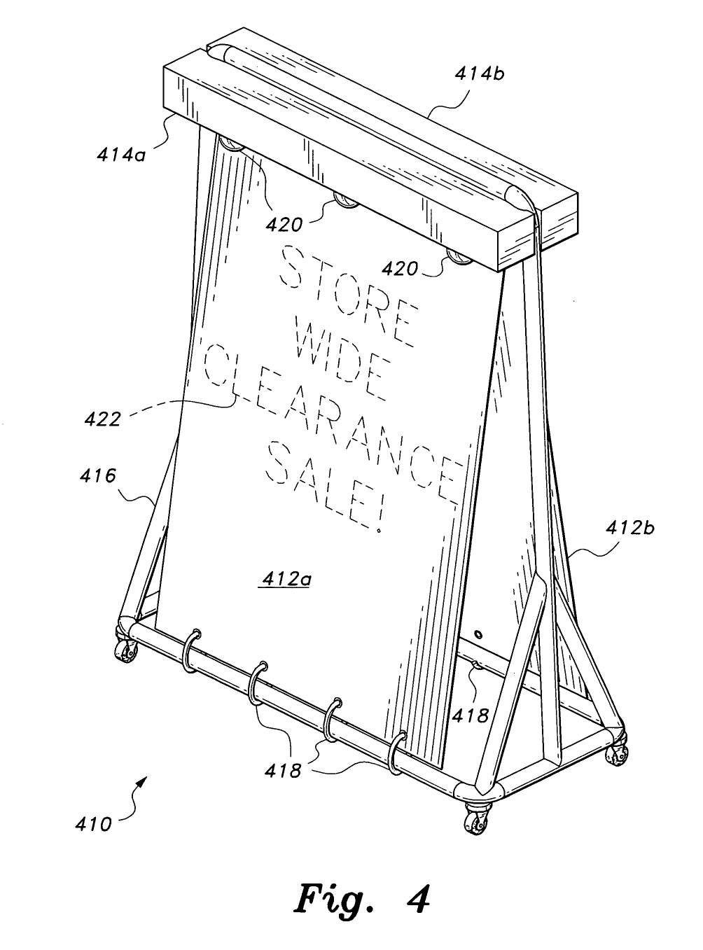

The protective cover units 110 are permanently installed within the elevator E, with the protective pads 112 retracting into their respective housings 114 to remain out of sight when not in use. When a large, heavy object, e.g., the desk furniture F of FIG. 1, is to be transported within an elevator E, the worker need only reach up to extend the protective pads 112 from their respective housings 114 and secure them in their extended positions by means of grommets 116 along the lower or distal edges of the pads 112 and cooperating hooks 118 installed along the bases of the walls W of the elevator E. Each of the units 110 includes one or more retracting mechanisms, as described further below and illustrated in FIGS. 4 through 7.

Each of the retractable protective cover units 110 may also include supplemental lighting 120, if so desired. The lighting 120 may comprise supplemental lighting drawing electrical power from the same electrical system as used to power the lighting within the building structure, or may comprise emergency lighting having a self-contained electrical storage battery for power, as is known in the art of emergency lighting.

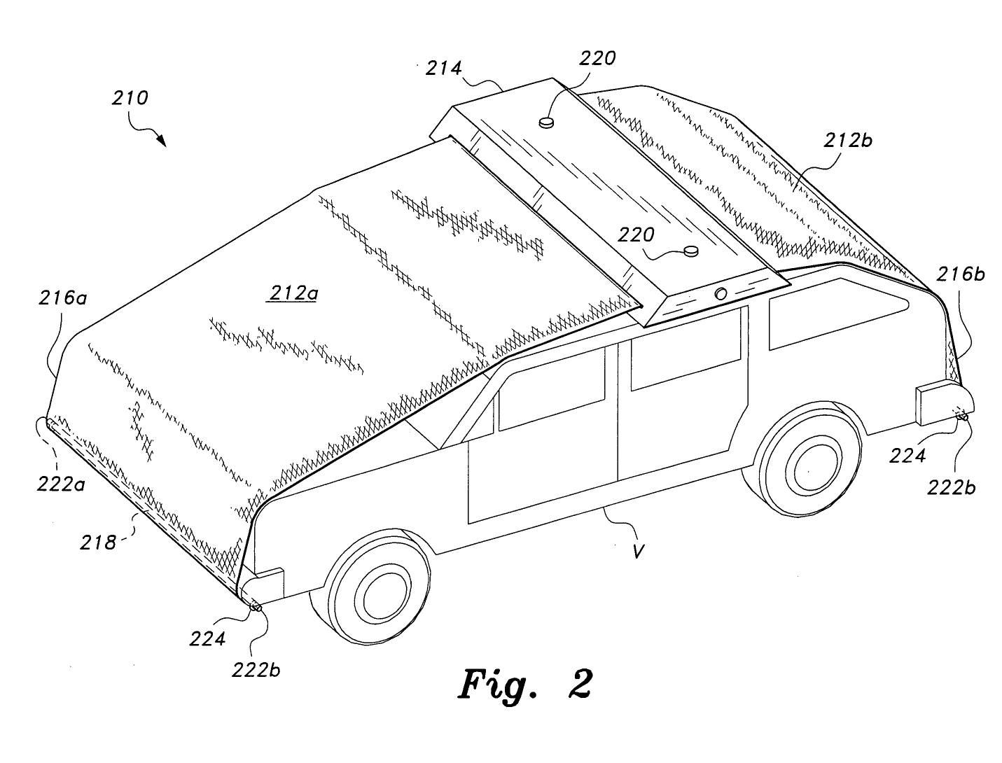

FIG. 2 provides an environmental perspective view of a second embodiment of a retractable panel, which is configured as a vehicle cover unit 210. The vehicle cover 210 includes a pair of rollers (shown in detail in FIG. 4, and described in detail further below) with a protective tarp, respectively 212a and 212b, extending therefrom. The rollers, and their retracted tarps 212a and 212b, are contained within a housing 214, which is removably mounted atop the vehicle V by conventional means, e.g., magnets, suction cups, etc. Each tarp has a second end, respectively 216a and 216b, disposed distally from the housing 214 when the tarps are extended. Each tarp end 216a, 216b has a rigid spreader bar 218 extending thereacross, with the first tarp spreader bar 218 and one end 222b of the second tarp spreader bar 218 being shown in FIG. 2. Each spreader bar 218 includes a first end 222a and an opposite second end 222b, with the corresponding ends of the vehicle bumpers having inwardly oriented hooks 224 depending therebelow.

The relatively lightweight covers or tarps 212a, 212b are easily extended manually against the spring tension of the spirator retractors installed upon the rollers within the housing 214, with the ends 222a, 222b of the spreader bars 218 being placed within the hooks 224 to secure the covers 212a, 212b in their extended positions over the vehicle V. The covers are easily retracted when desired by slightly extending them to pull the spreader bars 218 just past the hooks 224 and allowing the spring tension of the spirators within the housing 214 to retract the covers. The housing 214 may incorporate supplemental or emergency lighting 220 thereon, e.g., emergency hazard flashers, or flashing lights triggered by a remote control device to assist the operator in finding the vehicle in a large and crowded parking lot, etc.

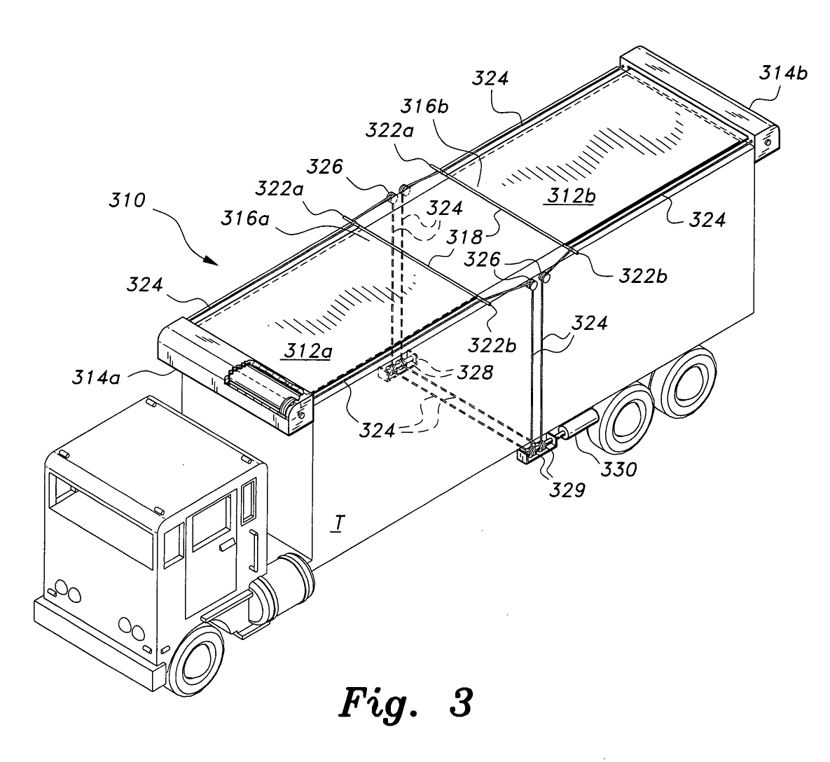

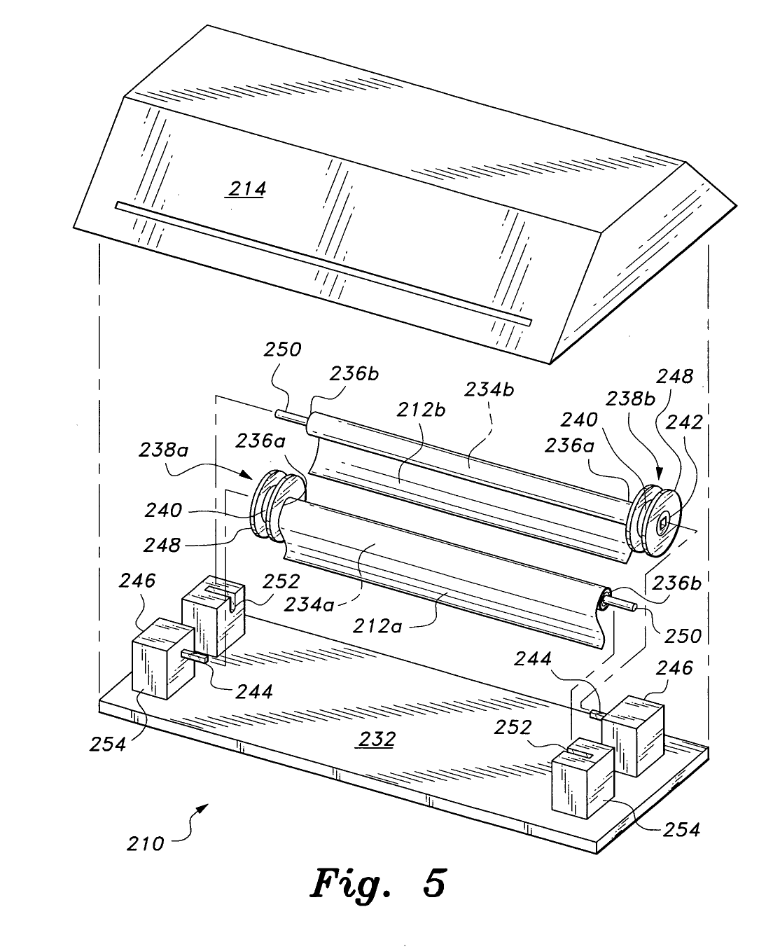

FIG. 3 provides an illustration of a somewhat heavier and more complex vehicle cover 310, or more particularly, a pair of load covers for a trash truck T or the like. The vehicle cover 310 includes a forward and a rearward roller (shown in detail in FIG. 5, and described in detail further below) with a protective tarp, respectively 312a and 312b, extending therefrom. The rollers, and their retracted tarps 312a and 312b, are respectively contained within forwardly and rearwardly installed housings 314a and 314b, mounted at the forward and rearward ends of the cargo or trash compartment of the trash truck T. Each tarp has a second end, respectively 316a and 316b, disposed distally from their respective housings 314a and 314b when the tarps are extended, with a rigid spreader bar 318 extending thereacross. Each spreader bar 318 includes a first end 322a and an opposite second end 322b, with a cable 324 extending from a spirator or roller within the housings 314a, 314b to each of the ends of the spreader bar 318.

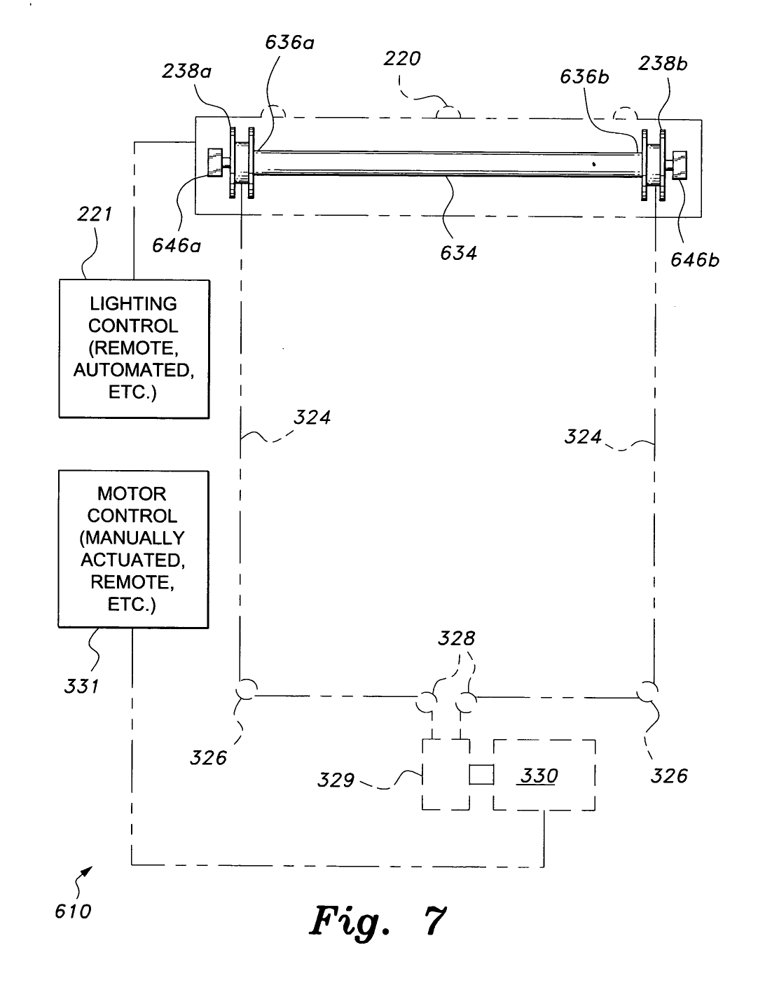

The cables 324, disposed on opposite sides of the assembly, are illustrated for a single roller configuration in FIG. 7 of the drawings. Each cable 324 extends beyond its respective spreader bar end 322a, 322b and passes around or through an intermediate guide 326 (pulley, etc.) disposed at the top of the central portion of the cargo or trash container of the truck T. The two right side cables extend through at least one secondary guide or pulley 328, thence passing laterally beneath the truck T to a takeup or extension reel 329 powered by an electric motor 330. The left side cable pair 324 extends through a similar system but avoids the need for the secondary guides or pulleys 328, as they remain along one side of the truck T. It will be seen that alternative cable takeup systems may be provided, e.g. moving the motor 330 and takeup reel 329 to the opposite side of the truck, providing a separate motor 330 and takeup reel 329 for each side, moving the motor(s) 330 and takeup reel(s) to the top of the cargo container to shorten the cable runs and eliminate the need for the intermediate cable guides or pulleys 326, etc.

The motor 330 may be powered from the vehicle electrical storage battery, or other conventional electrical power supply. The system may be actuated by conventional switches located on the housings 314a, 314b, or, alternatively, by a conventional control located in the cab of the truck T. The housings 314a, 314b may incorporate supplemental or emergency lighting thereon, generally as shown installed upon the housing 214 in the embodiment 210 of FIG. 2 and described further above.

FIG. 4 of the drawings provides an illustration of yet another embodiment of the retractable panel, comprising a portable advertising or display sign 410. The portable sign assembly 410 includes a pair of flexible panels or banners 412a, 412b, which retract into and extend from corresponding housings 414a, 414b. The housings 414a, 414b are supported upon a portable frame 416 or other suitable structure. While two panels 412a, 412b and housings 414a, 414b are shown in FIG. 4, it will be understood that only a single panel and housing may be installed on the frame 416, if so desired. The second ends of the banners or panels 412a, 412b are equipped with a series of hooks or the like 418, which may be secured about a bottom member of the frame 416, as shown in FIG. 4. The advertising display 410 of FIG. 4 may also include supplemental lighting 420, e.g., illumination disposed below the housings 414a, 414b, to illuminate a message(s) 422 provided on the banners 412a, 412b. Other lighting, not shown but similar to that shown in FIGS. 1-3 and described above, may be provided atop the housings 414a, 414b to attract attention.

FIG. 5 of the drawings provides further details of a double roller and panel device suitable for use as a centrally mounted vehicle cover as shown in FIG. 2 of the drawings. The housing 214 is secured atop a base 232, which is, in turn, secured to the top of the vehicle (e.g., car, boat, etc.) by conventional means. Two rollers, respectively 234a and 234b, are installed within the housing 214. Each roller includes a first end 236a and an opposite second end 236b.

Each of the first ends 236a includes a spirator, respectively 238a and 238b, attached thereto. These spirators, and other spirators used in the various embodiments of the present invention, have a coiled spring 240 formed of a flat length of spring steel. The inner end of the spring is affixed to a central hub 242, which has a non-circular receptacle that accepts a correspondingly shaped stationary post 244, which extends from a first or spirator attachment bracket 246. The opposite end of the spirator spring 240 is affixed to the reel 248, which rotates about the non-rotating hub 242. The spring 240 is in a normally tightly coiled configuration, and urges the reel 248 (and roller, e.g., roller 234a, and its attached panel or tarp, e.g., tarp 212a) to a retracted configuration, with the tarp or panel rolled upon the roller.

Extension of the tarp or panel against the tension of the spring 240 may only be maintained by holding or capturing the distal end of the panel, e.g., by hooks, extension mechanism, etc. Release of the extension means automatically results in the retraction of the tarp or panel onto the roller, as the roller is rotated by the spirator. The opposite second ends 236b of the rollers 234a, 234b have concentric shafts 250 extending therefrom, which rotate within receptacles 252 formed within second brackets or pillow blocks 254. The shafts 250 may include conventional bearings installed thereon, if so desired.

It will be noted that the two rollers 234a and 234b are oriented oppositely to one another, i.e., the first end 236a of the first roller 234a is adjacent the second end 236b of the second roller 234b. This is due to the opposed installations of their respective first or spirator mounting brackets 246 and second mounting brackets or pillow blocks 254. This allows the two rollers 234a, 234b, their respective tarps or panels 212a, 212b, and their spirators 238a, 238b to be assembled identically to one another, and turned around relative to one another for the panels 212a, 212b to extend and retract oppositely to one another, as shown in FIG. 2 of the drawings. It will be noted also that the receptacles formed in the spirator hubs 242 pass all the way through the hubs, thus allowing the spirators 238a, 238b to be oriented in whichever direction is desired to provide the desired direction of retraction.

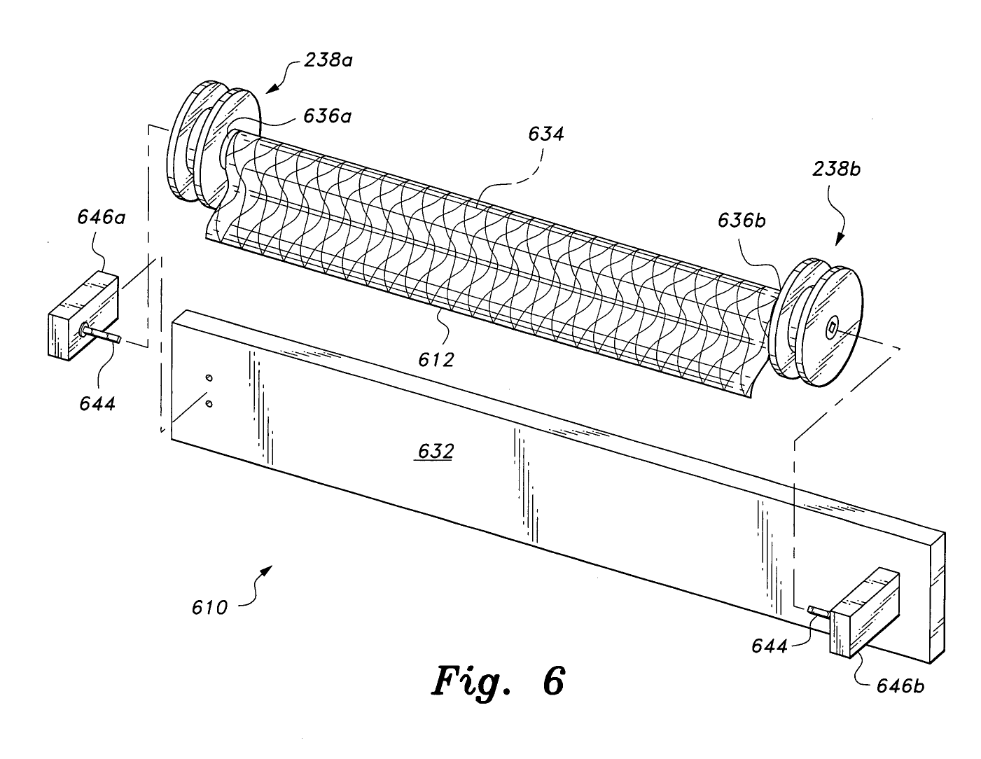

FIG. 6 provides an exploded perspective view of a single roller and dual spirator installation embodiment 610. Such a dual spirator installation may be necessary where a relatively heavy and/or lengthy panel 612 is used in order to provide the required retraction force. Two spirators are installed upon the roller 634, with a first spirator 238a installed upon the first end 636a of the roller 634, and a second spirator 238b installed upon the opposite second end 636b of the roller. The two mounting brackets 646a, 646b and their spirator hub engaging posts 644 are similar to one another, as both mate with identical spirators. At least one of the two mounting brackets, e.g., the first bracket 646a, is detachable from the base 632 in order to provide the proper installation sequence for the assembly.

FIG. 7 provides a schematic illustration of such a dual spirator, single roller embodiment 610, further incorporating motorized extension and lighting means. The panel, tarp, or pad is not shown in FIG. 7, for clarity in the drawing. However, the roller 634 includes first and second spirators, respectively 238a and 238b, at the opposite ends 636a and 636b thereof, mounted upon opposed first and second brackets 646a and 646b. In most cases, the cables normally provided with the spirator devices are not required. However, in the embodiment of FIG. 3 (cargo area cover for a truck) and FIG. 7, the cables 224 are retained for connection to the motorized extension system. The system includes a pair of intermediate or corner guides 326 (e.g., pulleys, fairleads, etc.), which guide the two cables 324 to at least one, and preferably a pair, of generally centrally disposed secondary guides 328. From the guides 328, the cables 324 continue to a panel extension or takeup reel 329, which is driven by a panel extension or takeup motor 330. The motor 330 may be actuated by a conventional motor control system 331, e.g., remotely controlled by a control device, such as a remote vehicle security control device, etc., or alternatively by a manually actuated switch at the motor 330 or elsewhere on the vehicle or in the system as desired. The device may include lighting means 220 for emergency, warning, or other illumination purposes, the lighting being disposed on the housing 212, for example, as shown in FIG. 2 of the drawings. The lighting 220 may be remotely or manually controlled by a conventional control device or system 221 similar to the motor control device or system 331 described above.

In conclusion, the retractable panel in its various embodiments greatly simplifies the construction and operation of such a device by using a spirator retraction mechanism to drive the roller for the panel of the device. The retractable panel mechanism is particularly well suited for use in storing, deploying, and retracting protective pads for installation in elevators, but may be adapted as dual roller embodiments incorporating spirator retraction devices at either or both ends of the rollers, as desired. The further incorporation of motorized extension means and lighting means with any of the various embodiments provides further utility and versatility for the retractable panels. Accordingly, the retractable panel will be greatly appreciated by those employed in elevator and building maintenance, as well as persons requiring a quickly installable and removable vehicle cover, advertising, display, or informational sign, or other similar device requiring a quickly extendable and retractable sheet or panel.

It is to be understood that the present invention is not limited to the embodiments described above, but encompasses any and all embodiments within the scope of the following claims.

I claim:

1. A retractable panel, comprising:
a housing;
at least one elongate roller having a first end and a second end opposite the first end, the roller being disposed within the housing;
at least one thin, elongate, flexible panel having a first end attached to the roller and a second end opposite the first end, the panel being selectively rolled about the roller in a retracted configuration and selectively extending from the housing in an extended configuration;
at least one spirator disposed within the housing, the spirator being connected to one end of the roller and biasing the panel to the retracted configuration;
a first bracket disposed within the housing, the first bracket supporting the first end of the roller;
a second bracket disposed within the housing, the second bracket supporting the second end of the roller; and
at least one light disposed externally upon the housing.

2. The retractable panel according to claim 1, wherein:
said at least one roller comprises a first roller and a second roller disposed within the housing, the first end of the first roller being disposed adjacent the second end of the second roller and the first end of the second roller being disposed adjacent the second end of the first roller;
said at least one panel comprises a first panel attached to the first roller and a second panel attached to the second roller; and
said at least one spirator comprises a first spirator connected to the first end of the first roller and a second spirator connected to the first end of the second roller.

3. The retractable panel according to claim 1, wherein the at least one light comprises an automatically actuated emergency light.

4. The retractable panel according to claim 1, wherein said panel comprises a protective pad.

5. The retractable panel according to claim 1, further including:
a rigid spreader bar disposed laterally across the second end of said panel, the spreader bar having a first end and a second end opposite the first end;
a first guide and a second guide disposed respectively opposite the first end and second end of the spreader bar; and
a panel extension motor disposed distally from the first and second guide;
wherein said at least one spirator comprises a first spirator and a second spirator disposed opposite the first spirator, the spirators being connected to said roller, the first and second spirators respectively having a first panel extension cable and a second panel extension cable selectively rolled thereon, the cables passing respectively about the first and second guides and communicating with the panel extension motor.

6. The retractable panel according to claim 1, further including at least one message disposed upon the panel.

7. A retractable panel, comprising:
a housing;
at least one elongate roller having a first end and a second end opposite the first end, the roller being disposed within the housing;
a thin, elongate, flexible panel having a first end attached to the roller and a second end opposite the first end, the panel being selectively rolled about the roller in a retracted configuration and selectively extending from the housing in an extended configuration;
at least one spirator disposed within the housing, the spirator being connected to one end of the roller and biasing the panel to the retracted configuration;
a first bracket disposed within the housing, the first bracket supporting the first end of the roller; and
a second bracket disposed within the housing, the second bracket supporting the second end of the roller.

8. The retractable panel according to claim 7, wherein:
said at least one roller comprises a first roller and a second roller disposed within the housing, the first end of the first roller being disposed adjacent the second end of the second roller and the first end of the second roller being disposed adjacent the second end of the first roller;
said at least one panel comprises a first panel attached to the first roller and a second panel attached to the second roller; and
said at least one spirator comprises a first spirator connected to the first end of the first roller and a second spirator connected to the first end of the second roller.

9. The retractable panel according to claim 7, further including at least one light disposed externally upon the housing.

10. The retractable panel according to claim 9, wherein the at least one light comprises an automatically actuated emergency light.

11. The retractable panel according to claim 7, wherein said panel comprises a protective pad.

12. The retractable panel according to claim 7, further including:
a rigid spreader bar disposed laterally across the second end of said panel, the spreader bar having a first end and a second end opposite the first end;
a first guide and a second guide disposed respectively opposite the first end and second end of the spreader bar; and
a panel extension motor disposed distally from the first and second guide;
wherein said at least one spirator comprises a first spirator and a second spirator disposed opposite the first spirator, the spirators being connected to said roller, the first and second spirators respectively having a first panel extension cable and a second panel extension cable selectively rolled thereon, the cables passing respectively about the first and second guides and communicating with the panel extension motor.

13. The retractable panel according to claim 7, further including at least one message disposed upon the panel.

14. A retractable panel, comprising:
a housing;
at least one elongate roller having a first end and a second end opposite the first end, the roller being disposed within the housing;
a thin, elongate, flexible panel having a first end attached to the roller and a second end opposite the first end, the panel being selectively rolled about the roller in a retracted configuration and selectively extending from the housing in an extended configuration;
at least one retraction spring mechanism disposed within the housing, the retraction spring mechanism being connected to one end of the roller and biasing the panel to the retracted configuration;
a first bracket disposed within the housing, the first bracket supporting the first end of the roller;
a second bracket disposed within the housing, the second bracket supporting the second end of the roller; and
at least one light disposed externally upon the housing.

15. The retractable panel according to claim 14, wherein the at least one retraction spring mechanism comprises aspirator.

16. The retractable panel according to claim 14, wherein:
said at least one roller comprises a first roller and a second roller disposed within the housing, the first end of the first roller being disposed adjacent the second end of the second roller and the first end of the second roller being disposed adjacent the second end of the first roller;
said at least one panel comprises a first panel attached to the first roller and a second panel attached to the second roller; and
said at least one retraction spring mechanism comprises a first retraction spring mechanism connected to the first end of the first roller and a second retraction spring mechanism connected to the first end of the second roller.

17. The retractable panel according to claim 14, wherein the at least one light comprises an automatically actuated emergency light.

18. The retractable panel according to claim 14, wherein said panel comprises a protective pad.

19. The retractable panel according to claim 14, further including:
a rigid spreader bar disposed laterally across the second end of said panel, the spreader bar having a first end and a second end opposite the first end;
a first guide and a second guide disposed respectively opposite the first end and second end of the spreader bar; and
a panel extension motor disposed distally from the first and second guide;
wherein said at least one retraction spring mechanism comprises a first retraction spring mechanism and a second retraction spring mechanism disposed opposite the first retraction spring mechanism, the retraction spring mechanisms communicating with the roller, the first and second spring mechanisms respectively having a first panel extension cable and a second panel extension cable selectively rolled upon the first retraction spring mechanism and second retraction spring mechanism, the cables passing respectively about the first and second guide and communicating with the panel extension motor.

20. The retractable panel according to claim 14, further including at least one message disposed upon the panel.
